(19) United States
(12) Patent Application Publication
(10) Pub. No.: US 2013/0013534 A1
(43) Pub. Date: Jan. 10, 2013

(54) HARDWARE-ASSISTED APPROACH FOR LOCAL TRIANGLE COUNTING IN GRAPHS

(75) Inventors: XIAO T. CHANG, BEIJING (CN); BUGRA GEDIK, WHITE PLAINS, NY (US); RUI HOU, BEIJING (CN); KUN WANG, BEIJING (CN); QIONG ZOU, BEIJING (CN)

(73) Assignee: INTERNATIONAL BUSINESS MACHINES CORPORATION, ARMONK, NY (US)

(21) Appl. No.: 13/178,181

(22) Filed: Jul. 7, 2011

(51) Int. Cl. G06F 15/18

(52) U.S. Cl. 706/12

(57) ABSTRACT

A method and apparatus are provided for hardware-assisted local triangle counting in a graph. The method includes converting vertex relationships of the graph into rule patterns. The method also includes compiling the rule patterns into a binary file, wherein the rule patterns are organized into a finite state machine. The method further includes loading at least a part of the binary file and a search string to be compared there against into a hardware pattern matching accelerator. The method additionally includes receiving a number of matching outputs from the pattern matching accelerator.

### BACKGROUND

1. Technical Field

The present invention relates generally to pattern matching and, in particular, to a hardware-assisted approach for local triangle counting in graphs.

2. Description of the Related Art

With the fast growing popularity of social network applications in our society, social network analysis has emerged as a key technology that provides better social networking services. This is achieved through automated discovery of relationships within the social network and using this insight to provide value-added services, such as friend discovery, personalized advertisements, and spam filtering to name a few.

Social networks are used to capture and represent the relationships between members of social systems at all scales, from interpersonal to international. Using graphs is a typical methodology to represent social networks, where nodes of the graph connote people and edges connote their relationships, such as short messages, mobile calls, and email exchanges.

### SUMMARY

According to an aspect of the present principles, there is provided a method of local triangle counting in a graph. The method includes converting vertex relationships of the graph into rule patterns. The method also includes compiling the rule patterns into a binary file, wherein the rule patterns are organized into a finite state machine. The further includes loading at least a part of the binary file and a search string to be compared there against into a hardware pattern matching accelerator. The method additionally includes receiving a number of matching outputs from the pattern matching accelerator.

According to another aspect of the present principles, there is provided a system for local triangle counting in a graph. The system includes a vertex relationship converter for converting vertex relationships of the graph into rule patterns. The system also includes a compiler for compiling the rule patterns into a binary file, wherein the rule patterns are organized into a finite state machine. The system further includes a hardware pattern matching accelerator for receiving at least a part of the binary file and a search string to be compared there against, and for providing a number of matching outputs.

According to yet another aspect of the present principles, there is provided a computer readable storage medium including a computer readable program for a method of local triangle counting in a graph, wherein the computer readable program when executed on a computer causes the computer to perform the respective steps of the aforementioned method.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary processing system 100 to which the present principles may be applied, in accordance with an embodiment of the present principles;

FIG. 2 is a block diagram showing a system 200 for local triangle counting in a graph, in accordance with an embodiment of the present principles;

FIG. 3 is a flow diagram showing a method 300 for local triangle counting in a graph, in accordance with an embodiment of the present principles;

FIG. 4 is a flow diagram showing another method 400 for local triangle counting in a graph, in accordance with an embodiment of the present principles;

FIG. 5 is a diagram showing a sample social network graph 500 to which the present principles may be applied, in accordance with an embodiment of the present principles;

FIG. 6 is a diagram showing an architecture 600 of a spam filter application running on System S, in accordance with an embodiment of the present principles;

FIG. 7 is a diagram showing an application flow graph 700 after parallelization is applied, in accordance with an embodiment of the present principles; and

FIG. 8 is a plot 800 of the number of threads versus the percentage of execution time consumed, in accordance with an embodiment of the present principles.

### DETAILED DESCRIPTION OF PREFERRED EMBODIMENTS

The present principles are directed to a hardware-assisted approach for local triangle counting in graphs. It is to be appreciated that the present principles are particularly suited for use with massive graphs. Such graphs may pertain to social network analysis and other applications, as readily contemplated by one of ordinary skill in the related art, given the teachings of the present principles provided herein.

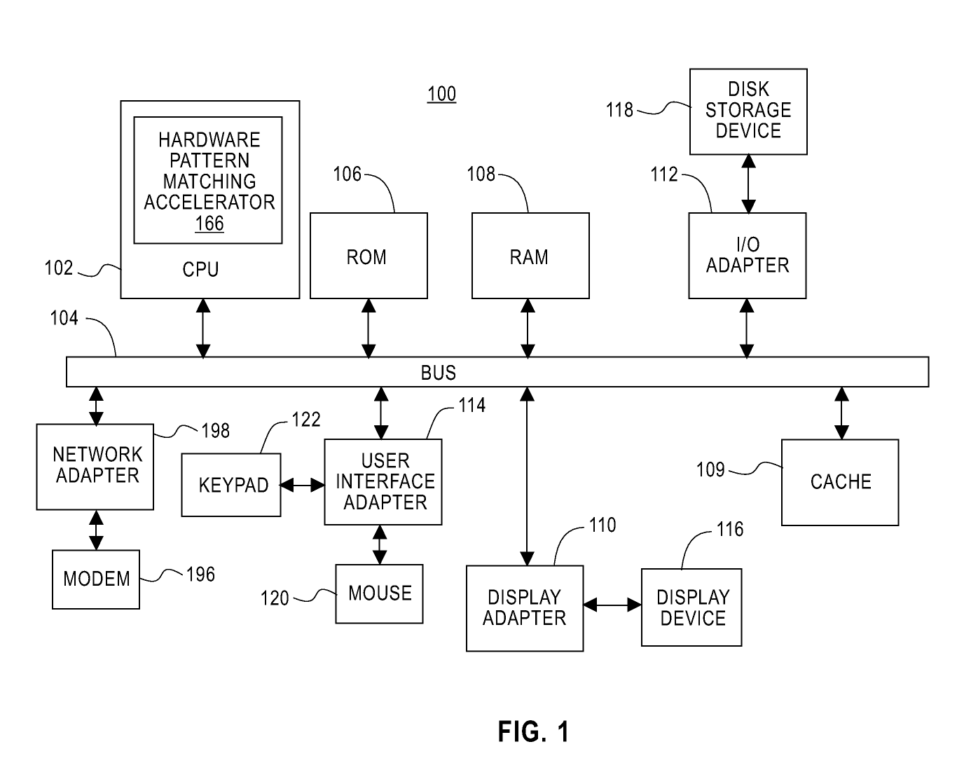

FIG. 1 shows an exemplary processing system 100 to which the present principles may be applied, in accordance with an embodiment of the present principles. The processing system 100 includes at least one processor (CPU) 102 operatively coupled to other components via a system bus 104. A read only memory (ROM) 106, a random access memory (RAM) 108, a display adapter 110, an I/O adapter 112, a user interface adapter 114, and a network adapter 198, are operatively coupled to the system bus 104.

A display device 116 is operatively coupled to system bus 104 by display adapter 110. A disk storage device (e.g., a magnetic or optical disk storage device) 118 is operatively coupled to system bus 104 by I/O adapter 112.

A mouse 120 and keyboard 122 are operatively coupled to system bus 104 by user interface adapter 114. The mouse 120 and keyboard 122 are used to input and output information to and from system 100.

A (digital and/or analog) modem 196 is operatively coupled to system bus 104 by network adapter 198.

It is to be appreciated that the at least one processor 102 includes a hardware pattern matching accelerator 166. While the hardware pattern matching accelerator 166 is shown included within the at least one processor 102, it is to be appreciated that the hardware pattern matching accelerator may be a separate device from the processor 102 in one or more other embodiments of the present principles.

Of course, the processing system 100 may also include other elements (not shown), including, but not limited to, a sound adapter and corresponding speaker(s), and so forth, as readily contemplated by one of skill in the art.

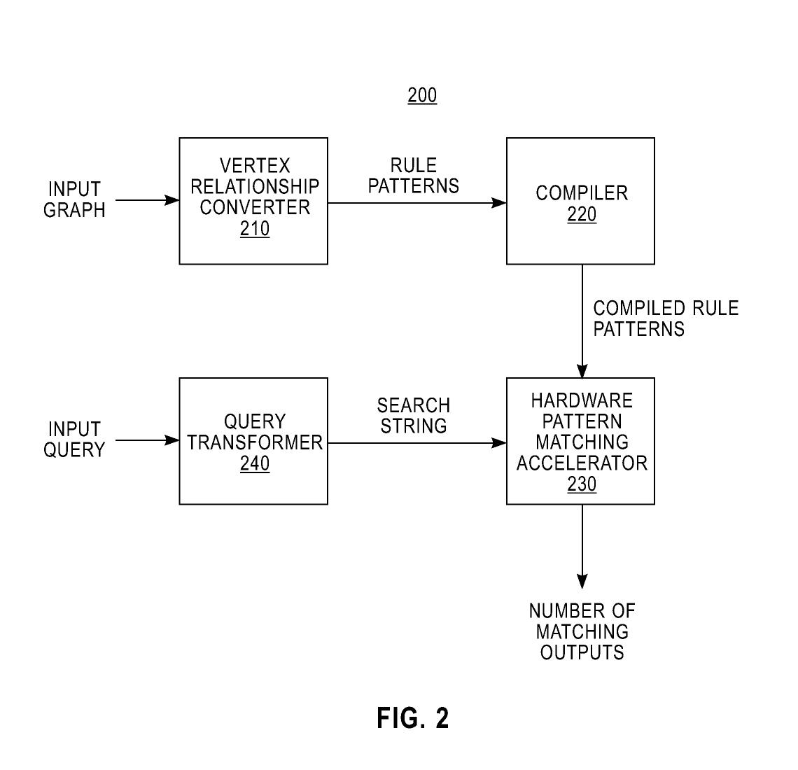

FIG. 2 shows a system 200 for local triangle counting in a graph, in accordance with an embodiment of the present principles. The system 200 includes a vertex relationship converter 210, a compiler 220, a hardware pattern matching accelerator 230, and a query transformer 240. The vertex relationship converter 210 receives an input graph and outputs rule patterns there for. The compiler 220 receives the rule patterns and outputs compiled rule patterns. In an embodiment, the compiler 220 may organize the rule patterns into a finite state machine. The query transformer 240 receives an input query and outputs a search string. The hardware pattern matching accelerator 230 receives the search string and all or part of the compiled rule patterns and outputs the number of matching outputs (between the search string and the compiled rule patterns). The functions of the elements of system 200 are described in further detail hereinafter.

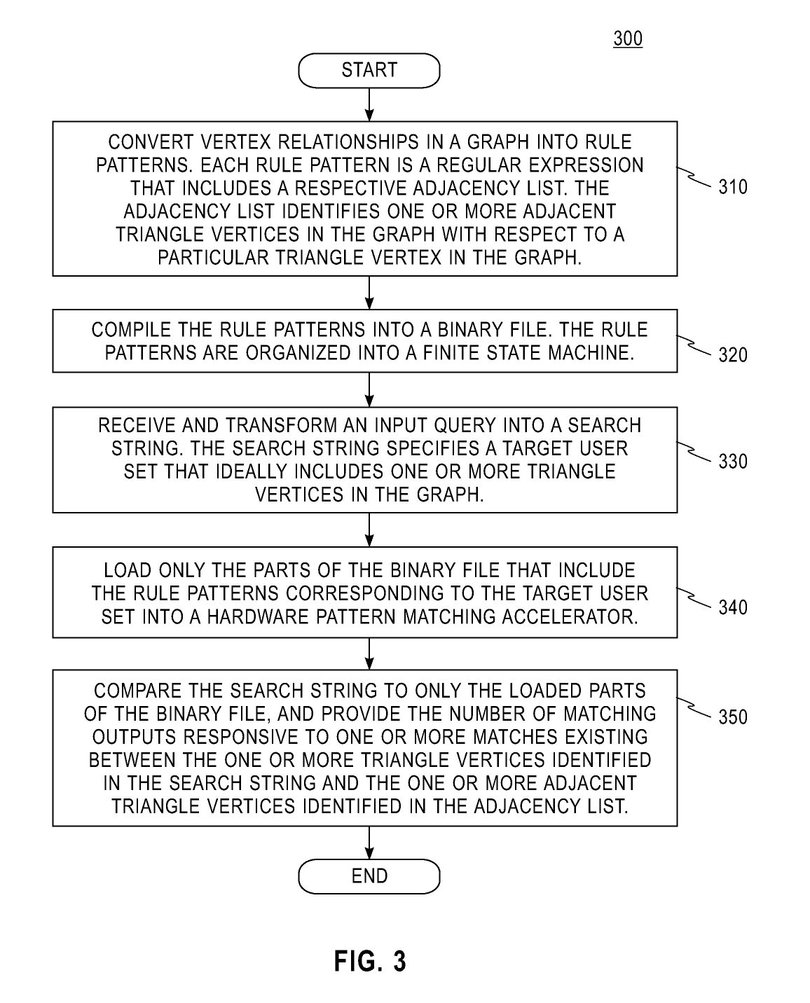

FIG. 3 shows a method 300 for local triangle counting in a graph, in accordance with an embodiment of the present principles. The method 300 of FIG. 3 pertains to the DirectSearch method described herein.

At step 310, vertex relationships in a current graph being processed (hereinafter the “graph”) are converted into rule patterns by the vertex relationship converter 210. Each of the rule patterns is a regular expression that includes a respective adjacency list. The adjacency list identifies one or more adjacent triangle vertices in the graph with respect to a particular triangle vertex in the graph.

At step 320, the rule patterns are compiled into a binary file (i.e., a pattern) by the compiler 220. Step 320 may include organizing the rule patterns into a finite state machine.

At step 330, an input query is received and transformed into a search string by the query transformer 240. The search string specifies a target user set that ideally includes one or more triangle vertices in the graph.

At step 340, only the parts of the binary file that include the rule patterns corresponding to the target user set are loaded into a hardware pattern matching accelerator 230.

At step 350, the search string is compared to only the loaded parts of the binary file by the hardware pattern matching accelerator 230, and the number of matching outputs is provided responsive to one or more matches existing between the one or more triangle vertices identified in the search string and the one or more adjacent triangle vertices identified in the adjacency list (of one or more of the rule patterns that are included in the comparison).

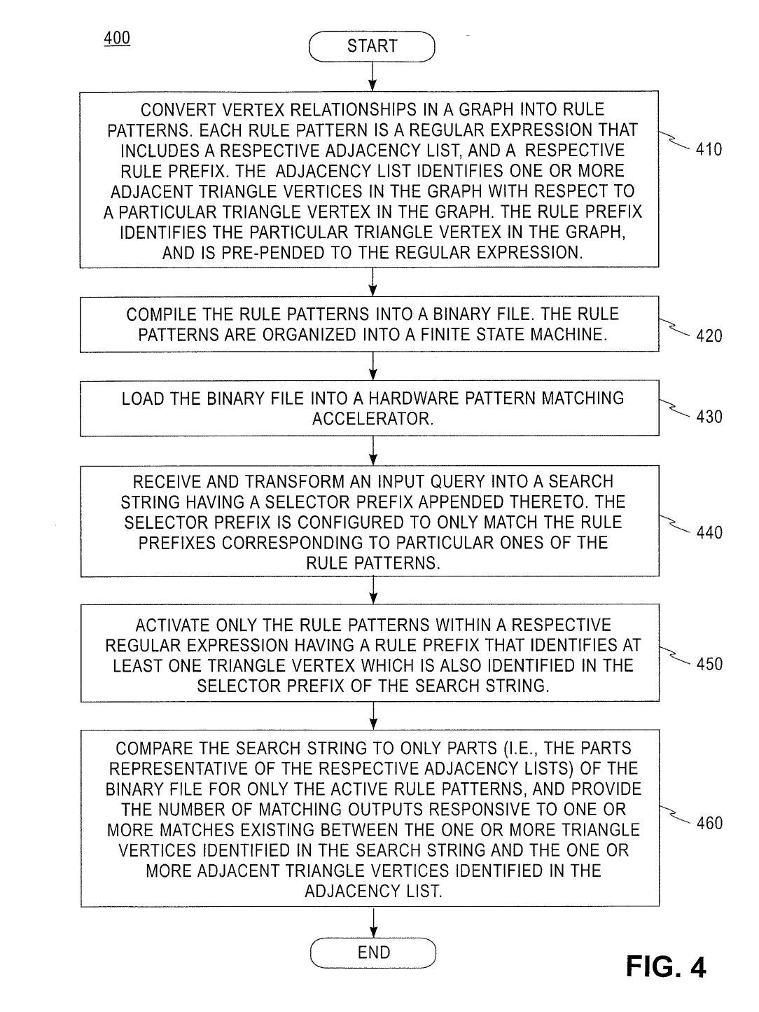

FIG. 4 shows another method 400 for local triangle counting in a graph, in accordance with an embodiment of the present principles. The method 400 of FIG. 4 pertains to the PrefixGuidedSearch method described herein.

At step 410, vertex relationships in a current graph being processed (hereinafter the “graph”) are converted into rule patterns by the vertex relationship converter 210. Each of the rule patterns is a regular expression that includes a respective adjacency list and a respective rule prefix. The adjacency list identifies one or more adjacent triangle vertices in the graph with respect to a particular triangle vertex in the graph. The rule prefix identifies the particular triangle vertex in the graph, and is pre-pended to the regular expression. Hence, the particular triangle vertex in the graph identified by the rule prefix is the same particular triangle vertex that the adjacent triangle vertices are determined with respect to.

At step 420, the rule patterns are compiled into a binary file by the compiler 220. Step 420 may include organizing the rule patterns into a finite state machine.

At step 430, the binary file is loaded into a hardware pattern matching accelerator 230. The binary file is only loaded once into the hardware pattern matching accelerator 230 for use in multiple comparisons, as the binary file is reusable. We note that in contrast to method 300, in method 400 the binary file may be loaded before the input query, since the binary file is reusable for subsequent comparisons and involves all rule patterns in contrast to method 300, with the caveat that only certain ones of the rule patterns are activated and hence used in the comparison.

At step 440, an input query is received and transformed into a search string having a selector prefix appended thereto by the query transformer 240. The search string ideally specifies a target user set that ideally includes one or more triangle vertices in the graph. The selector prefix is configured to only match the rule prefixes corresponding to particular ones of the rule patterns (i.e., the rule patterns to be activated for comparison at following step 450).

At step 450, only the rule patterns within a respective regular expression having a rule prefix that identifies at least one triangle vertex which is also identified in the selector prefix of the search string are activated.

At step 460, the search string is compared to only parts (i.e., the parts representative of the respective adjacency lists, which is located at a known location) of the binary file for only the active rule patterns by the hardware pattern matching accelerator 230, and the number of matching outputs is provided responsive to one or more matches existing between the one or more triangle vertices identified in the search string and the one or more adjacent triangle vertices identified in the adjacency list (of one or more of the rule patterns that are included in the comparison). While described as two separate steps, it is to be appreciated that step 450 can be considered to be part of step 460 in that rules are activated or de-activated with respect to the comparison and, hence, such corresponding activation and deactivation typically is performed right before the time of actual comparison and hence may be considered to be part of the comparison.

Moreover, it is to be appreciated that while the rule prefix and the selector prefix are described herein as prefixes, they may be located anywhere in the regular expression and the search string, respectively, as long as their locations are predetermined and correlated so that they may be compared there against.

We will now describe an exemplary environment in which the present principles may be applied. However, it is to be appreciated that the present principles are not limited to the following environment and, thus, may be described with respect to other environments, while maintaining the spirit of the present principles.

The proliferation of mobile devices, coupled with continuous connectivity, has resulted in a world where massive amounts of data is being produced, on a daily basis, as a result of online interactions between people. These interactions are often captured as relationships in a social network graph, by service providers such as mobile carriers or social web applications. Social network analysis is becoming a common technique for extracting business intelligence from social network graphs in order to improve customer experience and provide better service. Some applications in this domain require processing massive data flows with high-throughput and low-latency, in order to deliver timely results. A spam filter application used for streaming social network analysis (hereinafter referred to as “spam filter” in short) fits this description. Such a spam filter can be used for real time filtering of short messages in mobile communications, with the goal of preventing spam. The ever increasing volume of mobile users and rates of messages make real-time detection of spam a challenging problem with respect to performance and scalability. In accordance with an embodiment, we present a solution for the aforementioned spam filter application using the IBM wire-speed processor, a system-on-a-chip with specialized co-processors and integrated network I/O. This solution goes beyond the state-of-the-art by (i) using a novel implementation technique that takes advantage of the pattern matching accelerator to minimize the latency of spam detection, and (ii) employing hardware primitives to reduce the overhead caused by thread synchronization in order to achieve good scalability with respect to number of cores used. Furthermore, in an embodiment, the solution is implemented on System S, a commercial grade stream processing middleware. Nonetheless, we note that while the present principles are described with respect to a spam filter application, the IBM wire-speed processor, system S, and so forth, the present principles are not limited to the same and, thus, may be applied to other applications, other hardware pattern matching accelerators (beside the accelerator included in the wire-speed processor), other middleware, and so forth, as readily determined by one of ordinary skill in the art, while maintaining the spirit of the present principles.

Herein we tackle the performance and scalability problems of a spam filter as described above with a new computational approach for social network analysis. This approach originates from the wire-speed processor (WSP) project. The WSP represents a generic processor architecture in which processing cores, hardware accelerators, and I/O functions are closely coupled in a system-on-a-chip. The unique hardware features of the WSP that are leveraged by our solution are the pattern matching accelerator and the waitrsv primitive. The former provides hardware acceleration for running regular expression queries, whereas the latter provides an efficient way to synchronize application-level threads. However, given the teachings of the present principles provided herein, one of ordinary skill in the art will contemplate the preceding and other pattern matching accelerators and application-level thread synchronizers to which the present principles may be applied, while maintaining the spirit of the present principles. As used herein, the phrase “regular expression” denotes an expression that describes a set of strings. Regular expressions are usually used to provide a concise description of a set, without having to list all of the elements of the set. Thus, a regular expression provides a concise and flexible way to match strings of text.

Taking advantage of the pattern matching accelerator of the WSP, we develop a novel algorithm for the clustering coefficient computation, which is the main bottleneck operation in the aforementioned spam filter application. This new algorithm significantly improves the performance of spam detection (up to 3× compared to the state-of-the-art), as we illustrate using real-world data sets. Using the waitrsv primitive, we reduce the overhead of synchronization in the multi-threaded parallel implementation of the spam filter application. This results in good scalability as the number of threads increase, and significantly outperforms synchronization based on POSIX threads or spin-wait loops, especially when all the hardware threads in the WSP are put into use.

Spam Filter Application Problem Overview

Traditional anti-spam methods, such as scanning the message content for keywords or allocating a pre-defined quota on the number of short messages sent per person, usually do not provide satisfactory results, as they have obvious accuracy and usability shortcomings. Detecting spam based on social network analysis is a promising direction, which does not suffer from these shortcomings. However, unlike the traditional approaches, social network analysis requires frequent access to the social network graph to perform the necessary analysis to determine if a given message is spam or not. With the ever increasing number of mobile users and devices, and the volume of message communication, accurate and resource efficient detection of spam messages using social network analysis techniques becomes a major challenge.

The basic social network analysis approach we employ in a spam filter application for detecting spam messages serves as the basis for our hardware-assisted detection algorithm and parallelization strategy described herein.

In essence, the application distinguishes spam from regular messages according to personal relationships between callers and callees as represented by a social network graph. In this graph, a vertex vᵢ denotes a mobile phone user and an edge e_{i,j} between vᵢ and another vertex vⱼ (representing another user) indicates that the two users i and j know each other, as they have called one another in the past. The basic assumption behind such a model is that spam messages are usually sent out to a large number of randomly selected targets.

For a given message, the clustering coefficient is a measure of how connected a target user of the message is with the set of all target users of the message. If this measure is high, then it implies that the message is sent to a set of users that know each other for the most part and, thus, is not a spam message. To define this more formally, let z be a message and t_{z} be the set of users that are targets of this message. To compute the clustering coefficient for message z, denoted by CC_{z}, we first look at each user vεt_{z} in the target set of the message z and then compute the fraction of the users in the target set t_{z}−{v} that are also in the set of v's neighbors, denoted by eᵥ. This measure is given by |eᵥ∩t_{z}|/(|t_{z}|−1) for vεt_{z}. After averaging over all target users, we obtain the following:

$${CC}_{z} = {\sum }_{v ∈ {t}_{z}}^{ } \frac{\vert {e}_{v} ⋂ {t}_{z} \vert}{\vert {t}_{z} \vert \cdot ( \vert {t}_{z} \vert - 1 )}$$

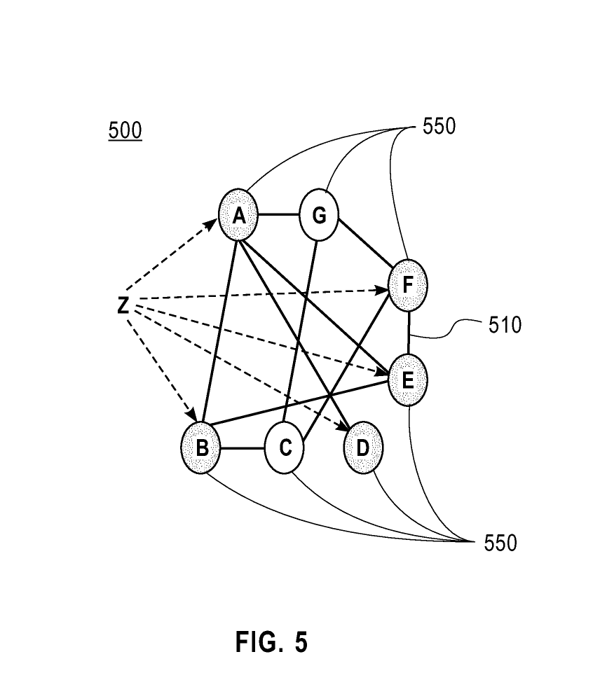

Given a social network graph augmented with a vertex representing the message z and edges connecting this vertex to the vertices in the target user set t_{z}, the numerator of the above equation is equal to the number of closed triplets around the central vertex that represents the message z. A closed triplet simply represents an edge between two vertices in the target user set t_{z}. This edge forms a triangle when connected with the vertex that represents the message z. In summary, in order to compute CC_{z}, we need to count the number of triangles formed by the vertex that represents z and the two vertices from the target user set t_{z} of the message z, where the latter two are neighbors in the social network graph. FIG. 5 shows a sample social network graph 500 to which the present principles may be applied, in accordance with an embodiment of the present principles. The graph 500 includes nodes A, B, C, D, E, F, and G. The relationships of these nodes constructs the social network graph 500. The graph 500 may serve as an input to step 310 of method 300 and/or as an input to step 410 of method 400, where in both steps 310 and 410 the vertex relationships in a graph are converted into rule patterns. Thus, an edge 510 between node E and node F means they have a connection or relationship. The nodes A, B, C, D, E, F, and G are triangle vertices collectively denoted by the reference numeral 550. Hence, in the example of FIG. 5, the clustering coefficient for message z is calculated as follows:

$${CC}_{z} = \frac{3 + 2 + 1 + 3 + 1}{5 \times ( 5 - 1 )} = 0.5 .$$

There exist two general categories of algorithms for counting closed triplets: exact counting; and approximating counting. The present principles are directed to exact counting of the clustering coefficient. The fastest exact counting methods use matrix-matrix multiplication and therefore have an overall time complexity of O(n^{2.371}), where n is the number of target users of the message. This is the state of the art complexity for matrix multiplication. However, the space complexity is O(n²) and thus these algorithms are not used in practice due to their high memory requirements. Listing algorithms are preferred in practice for large graphs due to their modest memory requirements. Edge-iterator is a representative listing algorithm and it has been shown that edge-iterator performs better on large-scale graphs compared to other alternatives. As a result, we use edge-iterator as the basic algorithm in one or more embodiments described herein. However, other listing algorithms may also be used, while maintaining the spirit of the present principles. Edge-iterator is described in further detail hereinafter.

In a typical configuration, the spam filter application manages a social network graph with several tens of millions of vertices. An important aspect of this dataset is that the social network evolves slowly. Thus, accurately scoring of incoming messages does not require updating the graph in a streaming fashion. Instead, the social network graph can be updated offline, using a batch process. In contrast, counting the number of closed triplets accurately is a key ingredient in our clustering coefficient computation that should be performed on a per-message basis. Interestingly, based on our profiling runs, we have established that the queries for assessing inter-user connectivity in social network graphs (used for the closed triplet counting) account for approximately 90% of the total execution time in determining whether a message is legitimate or not, when the edge-iterator algorithm is used.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

We now describe the fundamental technologies used in one or more embodiments of the present principles, namely: the WSP and its specific hardware features utilized by the present principles; and the System S stream processing middleware, and its programming language, SPL.

WSP Overview

The WSP is built based on a heterogeneous architecture that integrates multiple general purpose cores with several domain-specific accelerators and I/O functions, in a system-on-a-chip. It includes four distinct complexes: the processor compute complex; the accelerator complex; the interconnect complex; and the network I/O complex. Herein we focus on the former two, which facilitate efficient implementation of the spam filter application.

The accelerator complex includes a set of special purpose co-processors that are frequently used in many application domains. The WSP includes 4 such accelerators, namely: pattern matching; compression/decompression; cryptography; and XML accelerators. These accelerators are significantly more power efficient than general purpose processors and will exceed the performance of highly-tuned software alternatives running on general-purpose processors. Among these hardware accelerators, the present principles make use of the pattern matching engine.

The processor compute complex is composed of a large set of multi-threaded cores that provide high performance per watt and are optimized for parallel processing. There are 16 PowerPC cores, referred to as A2 cores, operating at 1.8 GHz. Each A2 core has 4 simultaneous threads of execution. Besides these two complexes, wait reservation is another technology we employ in one or more embodiments. The waitrsv primitive allows a thread to wait on a previously established reservation and wake up when that reservation is lost. We use waitrsv in a manner similar to monitor/mwait, as a more efficient way to perform fine-grained synchronization.

System S and SPL

Emerging streaming workloads and applications gave rise to new data management architectures as well as new principles for application development and evaluation. Several academic and commercial frameworks have been put in place for supporting these workloads.

System S is a stream processing middleware from IBM RESEARCH, which supports the execution of multiple streaming applications on a set of compute nodes, simultaneously. System S applications take the form of dataflow processing graphs. A flow graph includes a set of PEs (processing elements, i.e., execution containers for the application logic stated as a collection of operators) connected by streams, where each stream has a fixed schema and carries a series of tuples. The operators hosted by PEs implement stream analytics and can be distributed on several compute nodes. System S provides a multiplicity of services, such as fault tolerance mechanisms, scheduling and placement mechanisms, distributed job management, storage services, and security.

SPL is the programming language of System S. The SPL tooling includes a rapid application development environment, as well as visualization and debugging tools. The language can be used to compose parallel and distributed stream processing applications, in the form of operator-based dataflow graphs. The language makes available several operator toolkits, including: a stream relational toolkit that implements relational algebra operations in the streaming context; and an edge adapter toolkit that includes operators for ingesting data from external sources as well as publishing results to external consumers, such as network sockets, databases, file systems, as well as to proprietary middleware platforms. A distinctive feature of the SPL is its extensibility. New type-generic, configurable, and reusable operators can be added, enabling third parties to create application or domain-specific toolkits of operators.

Architecture of a Streaming Solution

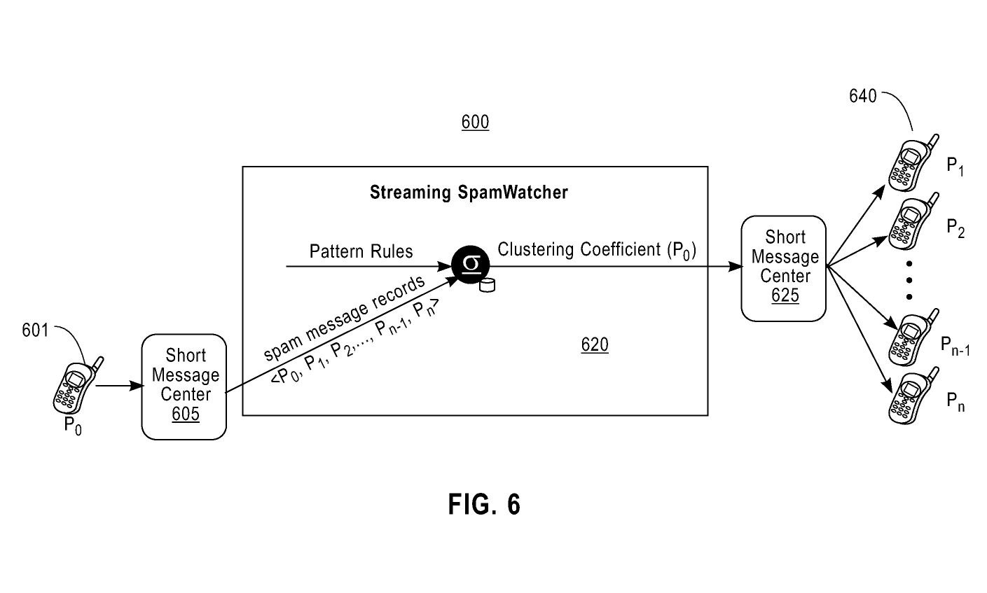

FIG. 6 shows an architecture 600 of a spam filter application running on System S, in accordance with an embodiment of the present principles. The architecture 600 includes a message sender 601, a short message center 605 at the sender side, the spam filter application 620, a short message center 625 at the receiver side, and a plurality of recipients 640. The application 620 receives, as input, a stream of short message events. Each event represents a short message that was sent from a source number P₀ 601 to a set of target numbers {P₁, . . . Pₙ} 640. For each event, the clustering coefficient is computed and compared against a threshold to detect if the short message involved is a spam message or not. If the clustering coefficient is smaller than or equal to a predefined threshold L, then the telecom operator will be informed that P₀ is a spam message sender and should be blacklisted. If not, then the message is considered as clean, and is forwarded to the list of users in its target set 640. The source number P₀ 601 may be considered to correspond to (message) source node Z in FIG. 5, while target numbers {P₁, . . . , Pₙ} 640 may be considered to correspond to nodes A, B, C, D, E, F, and G (collectively denoted by the reference numeral 550) in FIG. 5

The spam filter application can be implemented effectively as a streaming application. On the one hand, it follows the streaming paradigm as the computation performed is triggered by an external and continuous data source. On the other hand, the datasets can be partitioned and distributed across multiple backend servers or processing cores. We discuss the partition and distribution aspects of the problem in detail. In summary, System S provides a platform on which the spam filter application can be effectively deployed as a distributed stream processing application. Of course, other platforms can also be used in accordance with the present principles, while maintaining the spirit of the present principles.

Using WSP's Hardware on System S

As we mentioned earlier, clustering coefficient computation is the most time consuming component of the spam filter application. To address this, we propose to accelerate this computation using the pattern matching engine (PME) on the WSP. We outline hereinafter the main steps involved in accessing the PME from within an SPL application.

Before pattern matching can be performed using the PME, there are 3 preparation steps that have to be performed first, as follows.

(1) Express the patterns which will be used for the match, as regular expressions.

(2) Compile the regular expressions into a binary file. As part of the compilation, the patterns are organized into BART-based Finite State Machines.

(3) Load the pattern binary into the PME.

Once these steps are performed, data can be matched against the patterns. The compilation (step 2) takes a significant amount of time and cannot be executed too often. On the other hand, the overhead brought by the loading (step 3) is proportional to the size of the compiled pattern. As we discuss hereinafter, the algorithm we develop for the clustering coefficient computation relies on representing the social network graph as a pattern. Even though the compilation of patterns is a very expensive operation at this scale, it does not prevent us from utilizing the PME for the clustering coefficient computation. This is because the social network graph used by the spam filter application is slow changing and does not need to be updated in real-time.

Listing 1 gives the SPL pseudo code for performing pattern matching using the PME. The WSP provides C language APIs for using the PME and we have wrapped these APIs as SPL native functions to expose them within the streaming application. The get_pme_handle function call, shown in line 7, is used to load a binary pattern file, whose path it takes as a parameter. We assume that the binary pattern file was created by compiling the regular expression of interest, using the WSP's regular expression compiler. The function returns a handle, which can be used in a future search_pme function call to perform a match, as shown in line 8. The latter function takes as a parameter, in addition to the handle, an input string that will be matched against the pattern. The function returns (in an out-parameter) the number of matches that were found (tmp variable in the example).

### Listing 1. Pseudo-Code for PME Usage in SPL

1 stream < int 3 2 cc > result =
2 Clustering Coefficient (input)
3 {
4 onTuple input:
5 {
6 mutable int 3 2 tmp ;
7 pmeHandle = get_pme_handle (pattern_file) ;
8 search_pme ( pmeHandle, input, tmp) ;
9 }
10 output result: cc=tmp ;
11 }

Clustering Coefficient Computation

We now describe the PME-assisted pattern matching algorithms we developed for the clustering coefficient computation.

Base Algorithm without the PME

Among common clustering coefficient computation algorithms, edge-iterator is effective with respect to both memory and performance and thus we use it as our baseline. However, given the teachings of the present principles provided herein, we note that other coefficient computation algorithms can also be utilized in accordance with the present principles, while maintaining the spirit of the present principles.

Algorithm 1 gives the pseudo-code. The basic idea is to count the closed triplets around the vertex z that represents the source of the message. Lines 2 and 3 are used to get one edge [symbol] u, w [symbol] where uεt_{z} (u is in the target user set of z) and wεeᵤ (w is amongst the neighbors of u) in G; and line 4 checks whether [symbol] z, u, w [symbol] forms a closed triplet. This check can be implemented in different ways. A brute-force method simply iterates over every element in t_{z} to determine if wεt_{z}, yielding a total running time complexity of O(d·n²), where n is the size of the target user set of the message, i.e., n=|t_{z}|, and d is the average degree of a vertex in the graph. For messages that are likely to be spam, n is often much larger than d. Given this property, building a hash table out of t_{z} can reduce the cost of the wεt_{z} check to O(1). This brings the overall algorithmic complexity to O(d·n).

Algorithm 1 Basic algorithm without PME
1: CC_{z} ← 0
2: for u ∈ t_{z} do
3: for w∈ eᵤ do
4: if w∈ t_{z} then
5: CC_{z} ← CC_{z} +1
6: end if
7: end for
8: end for
9: CC_{z} ← CC_{z} /(|t_{z}|·(|t_{z}|−1))

Advanced Algorithms with the PME

The main steps involved in using the PME have been previously described herein. We now describe two algorithms that employ the PME. Both of these algorithms work by converting the graph into patterns and performing regular expression matches on these patterns to count the number of closed triplets. In what follows, we describe the DirectSearch and PrefixGuidedSearch algorithms we have developed using this idea to compute the clustering coefficient with PME acceleration. As part of this, we cover both the pattern representation of the graph and the input strings used with these patterns.

(1) DirectSearch: In this algorithm, we map the adjacency list representation of the graph to a pattern by converting each adjacency list into a regular expression. For a vertex u that is connected to vertices eᵤ={v₁, v₂, . . . , vₙ}, its associated regular expression is given by: v₁|v₂| . . . |vₙ. We refer to this regular expression as the rule for the vertex u. The graph 500 shown in FIG. 5 can be represented as shown below:

### Rule A: B|D|E|G

### Rule B: A|C|E

### Rule C: B|F|G

### Rule D: A

### Rule E: A|B|F

### Rule F: C|E|G

### Rule G: A|C|F

Algorithm 2 gives the pseudo-code for DirectSearch. The main idea is to load the set of vertex rules corresponding to the target user set t_{z} and then perform a search with the resulting pattern on the string representation of t_{z} as the input string. Each match represents a closed triplet. For instance, a match w from the rule of u represents a closed triplet (z, u, w). To see this, again consider the example given in FIG. 5. The input string will be ABDEF and for the rule of B, there will be 2 matches: A and E (as these are in the input string). These two represent 2 of the closed triplets: ZBA and ZBE.

The main advantage of this algorithm is that the counting of the closed triplets is done using a single match via the PME, where the input string is the target user set and the pattern is the set of regular expressions representing the rules of the vertices in the target user set. This step is performed by the search_pme call in line 6. The major disadvantage of the algorithm is that the set of rules that constitute the pattern is dependent on the target user set, which will be different for each message. As shown in lines 1-3, the rules for the vertices are retrieved using the pattern_of call and are added to the pattern via the get_pme_handle (for the first one) and add_pme_file (for all others) calls. While each rule is already pre-compiled into a regular expression in an offline step, loading them into the PME has a non-negligible cost. Assuming that the size of each compiled rule is O(d), then the loading part has a computational cost of O(d·n) and the search part has cost O(n). In short, the computational complexity of this algorithm is still O(d·n), but part of the computation is accelerated by the hardware.

Algorithm 2 DirectSearch Algorithm
Require: t_{z} ={v₁,...,vₙ}
1: handle ← get_pme_handle(pattern_of (v₁ ))
2: for i ∈ [2..n] do
3: add_pme_file(handle, pattern_of(vᵢ ))
4: end for
5: input ← stringify(t_{z} )
6: CC_{z} ← search_pme(handle, input)
7: CC_{z} ← CC_{z} /(n·(n − 1))

(2) PrefixGuidedSearch: In this algorithm, we improve upon the DirectSearch algorithm by avoiding the individual loads of vertex rules for each message. Instead, we create a single pattern that combines the rules of all vertices and load it once into the PME. All input strings are searched using this same pattern. The main challenge in achieving this is to avoid the activation of rules for vertices that are not in the target user set of the current message. In order to achieve this, we update the vertex rules to include a rule prefix that incorporates the vertex itself into the regular expression. Accordingly, we update the search string to include a selector prefix that identifies the vertex rules that need to be active.

As an example, again consider FIG. 5. We extend the input string ABDEF into ABDEF#ABDEF. The first part, that is the rule prefix, indicates the set of vertices whose rules should be active; and the second part indicates the set of vertices we are looking for in the adjacency lists of the vertices in the target user set. To understand how the rules are modified to work with this new input string, let us consider the rules for B and G as examples. Note that the rule for B should be active, whereas the rule for G should be inactive, since the former is in the selector prefix, but the latter is not.

Rule B: B[̂#]*#[̂#]*(A|C|E)
Rule G: G[̂#]*#[̂#]*(A|C|F)

If you look at the rule prefixes, that is B[̂#]*# for rule of B and G[̂#]*# for rule of G, it is easy to see that they will only match an input string whose selector prefix includes the rule vertex. For example, B[̂#]*# will match ABDEF# but G[̂#]*# will not match. This will turn off the rule for vertex G, while enabling the one for B. The second part of a rule simply includes the adjacency list of the rule vertex, as in the DirectSearch algorithm. The second parts of the rules are matched against the second part of the input string, in order to count the number of neighbors of the active rule vertex that are also in the target user set, thus forming a closed triplet. Concretely, matching ABDEF#ABDEF (the input string) against B[̂#]*#[̂#]*(A|C|E) (the rule of vertex B) will yield 2 matches: BDEF#A and BDEF#ABDE, corresponding to the closed triplets: ZBA and ZBE.

The complete set of rules for the graph 500 in FIG. 5 is given as follows:

Rule A: A[̂#]*#[̂#]*(B|D|E|G)
Rule B: B[̂#]*#[̂#]*(A|C|E)
Rule C: C[̂#]*#[̂#]*(B|F|G)
Rule D: D[̂#]*#[̂#]*A
Rule E: E[̂#]*#[̂#]*(A|B|F)
Rule F: F[̂#]*#[̂#]*(C|E|G)
Rule G: G[̂#]*#[̂#]*(A|C|F)

Algorithm 3 gives the pseudo-code for PrefixGuidedSearch. Note that the algorithm does not involve loading rules on a per-message basis. Instead, the set of all vertex rules are compiled off-line and are loaded into the PME once. For each message, the input string is constructed by simply appending the string representation for the target user set to itself, with the # character separating the two parts. A single search is made using the search_pme call. As a result, the computational complexity of this algorithm is O(n).

Algorithm 3 PrefixGuidedSearch Algorithm
Require: handle: global variable representing the precompiled pattern
1: input ← stringify(t_{z} )+ “#” + stringify(t_{z} )
2: CC_{z} ← search_pme(handle, input)
3: CC_{z} ← CC_{z} /(|t_{z}|·(|t_{z}|−1))

Multi-Threaded Implementation

We have introduced different algorithms to compute the clustering coefficient. We now describe how to parallelize these algorithms, including the data partitioning scheme used for the graph, the distribution mechanism used for the queries, and the synchronization techniques used for combining the results.

Parallelization Strategy

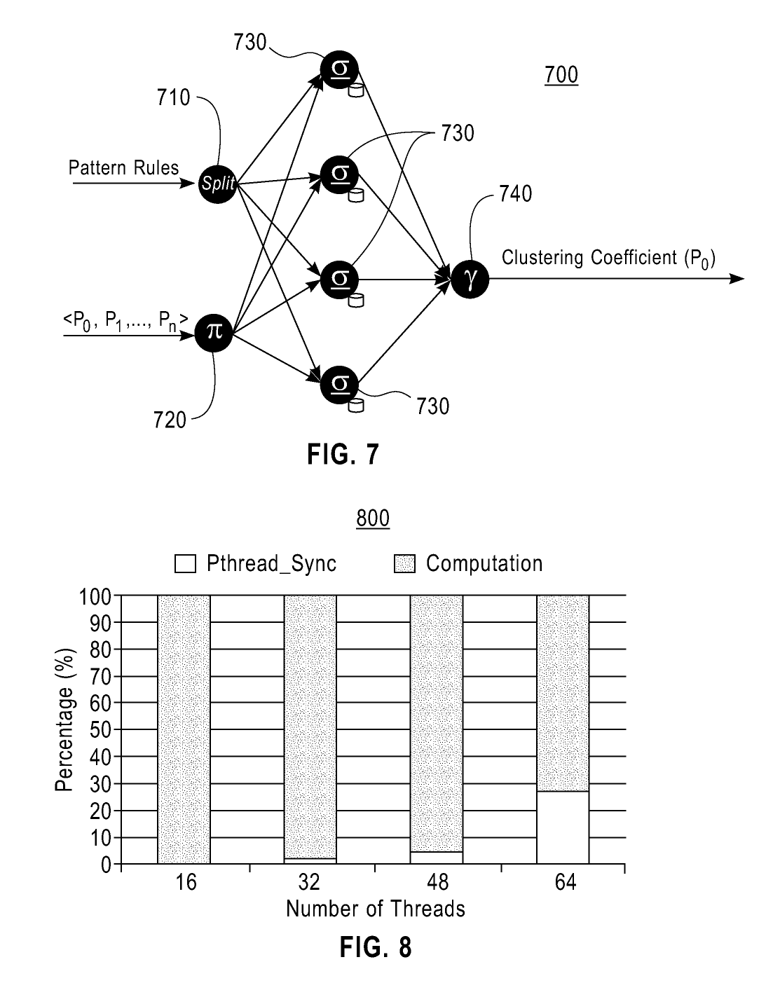

To increase the available parallelism, we partition the data set and replicate the queries to these partitions. FIG. 7 shows the application flow graph 700 after parallelization is applied, in accordance with an embodiment of the present principles. The partitioning of the social network graph 500 is achieved by applying the split operator 710 on the vertices (e.g., vertices 550 of graph 500). For the edge-iterator algorithm, this will result in distributing the adjacency lists amongst the partitions, whereas for the PME-based algorithms it will result in distributing the vertex rules (relating to, e.g., step 310 of method 300 and step 410 of method 400). This data partitioning step is performed when the graph 500 is first loaded. The queries (e.g., received at step 330 of method 300 and step 400 of method 400) are routed to all partitions using the π operator 720, and are processed by each partition thread using the σ operator 730, and finally the result is aggregated using the γ operator 740. The aggregation of results require the processing step for each partition to complete, thus a barrier synchronization step is involved.

Overall, the effectiveness of our load balancing scheme depends on how well the split operator 710 spreads the data set. If the subsets of query vertices that apply to each partition are uniformly sized, better load balancing will be achieved. We use a hand-tuned hash function to implement the split operator 710 in order to minimize skew.

Algorithmic Scalability

It is easy to see that the edge-iterator algorithm will scale linearly with the number of partitions, as the outer most loop will only iterate over the set of query vertices that belong to the current partition. However, the scalability of the PME-based algorithms is not as obvious. For the DirectSearch algorithm, the input string used for the pattern matching has to be the same independent of the number of partitions used. For the PrefixGuidedSearch algorithm, the selector prefix part of the input string can include only the vertices that belong to the current partition. However, the remaining part of the input string does not change and thus the overall size of the input string is still proportional to the number of vertices in the query. This is problematic at first, as we have mentioned herein that the cost of the regular expression matching via the PME depends on the size of the input string only.

There are two important characteristics of the PME that makes the DirectSearch and the PrefixGuidedSearch algorithms scale. First, the PME supports executing pattern searches concurrently using multiple threads. Up to 16 concurrent searches are supported. Second, the cost of doing a pattern match via the PME depends on the number of contexts needed to store the pattern, in addition to the size of the input string. The PME has up to 1024 contexts. While for small patterns (taking at most 1 context) the cost of the matching solely depends on the size of the input string, when the patterns get large, the matching (the search_pme call) is performed by doing a regular expression search (regex_search call) on each context in the partition, in a linear fashion. For a large pattern that takes up all the contexts, a single threaded implementation will result in making 1024 regex_search calls to process a query, whereas a multi-threaded implementation that uses N≦16 partitions will run 1024/N such searches on each one of the N threads.

Basic Synchronization

The basic version of our multithreaded implementation uses the Pthreads library for synchronization. NPTL implementation of Pthreads on Linux relies on futexes for synchronization, which is a mechanism provided by the Linux kernel as a building block for fast users-pace locking. In this implementation, a thread that waits on a condition variable (via pthread_cond_wait) makes a futex system call with a FUTEX_WAIT argument, which causes the thread to be suspended and de-scheduled. When the worker notifies the blocked thread (via pthread_cond_signal), a futex system call with a FUTEX_WAKE argument is made, which causes the waiting thread to be awakened and rescheduled.

When the number of threads is small, the overhead brought by synchronization can be ignored. However, with the increasing number of threads, it becomes a significant factor when compared to the time spent on computation. FIG. 8 is a plot 800 of the number of threads versus the percentage of execution time consumed, in accordance with an embodiment of the present principles. The plot 800 breaks down the execution time of the edge-iterator algorithm, showing the time spent on synchronization and the time spent on computation. FIG. 8 shows that the overhead of synchronization is around 4% for 48 threads and 28% for 64 threads. For PME-based algorithms that are faster than the edge-iterator algorithm, this cost is even more pronounced.

Synchronization with Waitrsv

IBM WSP introduced a new hardware instruction called wait. The wait instruction enables a logical processor to enter into an performance-optimized state while waiting for a single store to a given address. This address can be set-up by the lwarx primitive, on any PowerPC core. Different from the monitor/mwait instructions provided by INTEL's Prescott core at privilege level 0, these two instructions are available at the user-level. The wait and lwarx primitives are used together to create the waitrsv primitive on the WSP, which enables programmers to synchronize application level threads on hyper-threaded cores.

In particular, the lwarx primitive atomically performs a read and sets the reservation on an address, which notifies the monitoring hardware to detect stores to this address. On the other hand, the wait primitive puts the processor into the low power state until a store on the monitored address, or a timer interrupt happens. It is architecturally similar to executing nop instructions while waiting for a store to the address set up by lwarx or a timer interrupt. However, when other threads are available for execution on a hyperthreaded core, the processor can execute those threads, without stalling. When used together, these two primitives provide an application-level synchronization mechanism that avoids the overhead of OS-level scheduling when compared to the futex-based synchronization primitives of the Pthreads library.

### Listing 2. Waitrsv Primitive Usage

1 void waitrsv (void* pbuffer) {
2 uint32_t val;
3 asm volatile(
4 loop:
5 lwarx %0, 0, %1 // load and make reservation
6 cmp %0, 0 // exit if the value is non-zero
7 bne exit
8 wait // make the thread reliquish resources
9 // and sleep until reservation is lost
10 b loop
11 exit
12 : ″=&r″ (val)
13 : ″r″ (pbuffer));
14 }

Listing 2 shows the implementation of the waitrsv primitive in our application, which sets up a reservation and waits for the reservation to be cleared. As mentioned earlier, the wait could unblock due to events other than a write to the monitored address, such as an interrupt. As a result, we compare the current value of the monitored address against the original value, in order to determine if the exit from the wait resulted from a write or a different event. If it was due to an interrupt, then the wait must be executed again. However, the thread does not automatically go back into wait state after the interrupt is serviced. Thus, we repeat the reservation setup step via lwarx, before re-issuing the wait.

### Listing 3. Pseucode for CC Thread

1 void Transmitter_Thread( ) {
2 while(1) {
3 Recv(buf);
4 Write(Transmitter_CC, buf);
5 }
6 }
7 void CC_Thread( ) {
8 while(1) {
9 waitrsv(Transmitter_CC);
10 CC = PrefixGuidedSearch(Transmitter_CC, pmeHandle);
11 Write(CC_Aggregate, CC);
12 }
13 }

Listing 3 gives the pseudo-code of the thread synchronization used in our implementation of the spam filter application, based on the waitrsv primitive. Here, CC computation thread represents \acute{σ} operator 730 and transmitter thread means π operator 720. When the transmitter thread receives a query, it will write it into the memory areas shared with the CC computation threads (line 4). Once a CC computation thread detects the memory change via waitrsv, it starts the regular expression search using the PME (line 10). Once complete, it puts the result into the memory are shared with the aggregation thread (line 11) (aggregation thread represents γ operator 740). While not shown here for brevity, the aggregation thread uses the waitrsv primitive to implement barrier synchronization, in order to wait for all CC threads to complete their work.

Performance of Synchronization

Here, we provide a brief performance comparison of the synchronization primitives used. For this comparison, we use the IBM Mambo full-system simulator in order to show fine-grained results. A partitioning setup with N=4 is used for this comparison, as shown in FIG. 7.

We measure the following quantities: T_{wakeup} and T_{notify}·T_{wakeup} is the time between the notification of the CC thread and the moment that it is actually awakened. T_{notify} is the time transmitter thread spends in invoking the appropriate notification primitive.

TABLE 1

| primitive | T_{wakeup} | T_{notify} |
|---|---|---|
| Pthreads | 92472 | 55917 |
| waitrsv | 181 | 3276 |

TABLE 1 shows the cost of wakeup and notify (in cycles), in accordance with an embodiment of the present principles. Here, TABLE 1 presents the results from the evaluation of implementations with Pthreads and waitrsv, given in processor cycles. As shown, Pthreads implementation suffers from high wakeup and notification times, due to the long kernel control paths involved for both rescheduling and notifying the waiting thread. For waitrsv, the wakeup and notify are both very efficient, the former taking 0.2% of the cycles taken by the Pthreads alternative.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method of local triangle counting in a graph, comprising:
converting vertex relationships of the graph into rule patterns;
compiling the rule patterns into a binary file, wherein the rule patterns are organized into a finite state machine;
loading at least a part of the binary file and a search string to be compared there against into a hardware pattern matching accelerator; and
receiving a number of matching outputs from the pattern matching accelerator.

2. The method of claim 1, wherein each of the rule patterns is a regular expression.

3. The method of claim 2, wherein the regular expression includes an adjacency list, the adjacency list identifying one or more adjacent triangle vertices in the graph.

4. The method of claim 3, wherein a respective one of the matching outputs is provided responsive to a match existing between one of the one or more adjacent triangle vertices identified in the adjacency list and a particular target triangle vertex identified in the search string.

5. The method of claim 3, wherein only parts of the binary file that include the rule patterns corresponding to a target user set specified in the search string are loaded into the hardware pattern matching accelerator for comparison against the search string.

6. The method of claim 3, wherein the regular expression further includes a rule identifier, the rule identifier being located at a predetermined location in the expression, the rule identifier identifying a respective triangle vertex in the graph.

7. The method of claim 6, wherein the rule identifier is configured to be a rule prefix pre-pended to the expression.

8. The method of claim 6, wherein the rule patterns for all of the vertices in the graph are combined into a single pattern represented by the binary file, and the single pattern is loaded once and is re-usable thereafter by the hardware pattern matching accelerator for multiple comparisons against various search strings.

9. The method of claim 6, further comprising including a selector at a predetermined location in the search string, the selector being configured to only match rule identifiers corresponding to particular ones of the rule patterns.

10. The method of claim 9, wherein the selector is configured to be a selector prefix pre-pended to the search string.

11. The method of claim 9, wherein only the particular rule patterns having the rule identifiers that match the selector are activated for a given comparison against the search string.

12. The method of claim 11, wherein only active rule patterns are used by the hardware pattern matching accelerator for the given comparison from among a set of rule patterns that include the active rule patterns and inactive rule patterns.

13-25. (canceled)
